(19) United States
(12) Patent Application Publication
(10) Pub. No.: US 2016/0079680 A1
(43) Pub. Date: Mar. 17, 2016

(54) A DISH-SHAPED ELEMENT, AN ANTENNA COMPRISING THE DISH-SHAPED ELEMENT AND A METHOD OF PROVIDING A DISH-SHAPED ELEMENT

(71) Applicant: THRANE & THRANE A/S, Kgs. Lyngby (DK)

(72) Inventor: Christian STØTTRUP, Copenhagen (DK)

(73) Assignee: THRANE & THRANE A/S, Kgs, Lyngby (DK)

(21) Appl. No.: 14/784,553

(22) PCT Filed: Apr. 14, 2014
(86) PCT No.: PCT/EP2014/057527

§ 371 Date: Oct. 14, 2015

(30) Foreign Application Priority Data
Apr. 18, 2013 (DK) PA 2013 70219

(51) Int. Cl. H01Q 15/16; H01Q 1/42; H01Q 15/14; H01Q 21/00; H01Q 19/17; H01Q 19/13

(52) U.S. Cl. CPC H01Q 15/16; H01Q 19/17; H01Q 19/13; H01Q 15/141; H01Q 21/0087; H01Q 1/42

(57) ABSTRACT

A dish-shaped element (10), such as a parabola, for use in an antenna for receiving and/or transmitting information, the element comprising a dish-shaped part (12) having a first side and a second side opposite to the first side as well as a first outer rim portion (12′) and a ring-shaped part (14) attached to the second side of the dish-shaped part, the ring-shaped part being attached to a predetermined area of the second side, the predetermined area extending from the first rim portion and no more than 25% of a distance, along the opposite side, from one point on the first rim portion to a second point on an opposite side of the first rim portion. The dish-shaped part may be forced into a desired shape while the ring-shaped part is glued thereto.

The present invention relates to a reinforced dish-shaped element, such as a parabolic reflector for use in an antenna or a disc on which a number of radiation emitters or receivers are provided, for example

A problem in relation to such parabolic reflectors or flat substrates is that dimensional stability is important in that a difference in path length of radiation reflected by the reflector or received by two receivers will cause a detrimental effect in the radiation reflected and/or signal output. Naturally, the lower the wavelength, the lower will acceptable dimensional deviations be.

This problem is especially seen in reflectors or receivers/transmitters for use in directional systems where the direction of the reflector/substrate is desired rotatable, in that the reflector/substrate is desired both dimensionally stable as well as light and compact. Thus, it is not desired to provide a large scaffold on the back of the reflector/substrate in order to ensure its dimensional stability.

In a first aspect, the invention relates to a dish-shaped element for use in an antenna for receiving and/or transmitting information, the element comprising:
a dish-shaped part having a first side, a second side opposite to the first side, as well as a first outer rim portion,
a ring-shaped part attached to the second, opposite side of the dish-shaped part, the ring-shaped part being attached to a predetermined area of the second side, the predetermined area extending from the first rim portion and no more than 25% of a distance, along the second side, from one point on the first rim portion to a second point, on an opposite side of the first rim portion.

In the present context, a dish-shaped part is an element, formed by one part of a plurality of parts attached to or fixed to each other, which together defines the first surface or side. This surface or side may be unbroken or may be defined by a number of individual elements or parts.

The dish-shaped part has a second side opposite to the first side. Usually, the dish-shaped part is made of a relatively thin material. In this context, “relatively” will mean that a mean thickness of the dish-shaped part in a direction perpendicular to the first side is no more than 20%, such as no more than 10%, such as no more than 5%, such as no more than 1%, of a largest dimension of the dish-shaped part.

In some situations, the dish-shaped part is made of a dish-shaped sheet of material, whereby the overall thickness of the dish-shaped part may be more or less the same over a surface of the first side. In that manner, if the first side is concave, the second side is a convex side. This, however, is not a requirement, and the second side may have any shape desired.

The present dish-shaped element may be for use in an antenna if it, for example, the dish-shaped part has reflective properties in a suitable frequency interval, such as 10-35 GHz (the so-called Ku, Ka and K bands). In that or another situation, the dish-shaped element may be for use in an antenna, if the first surface has a predetermined shape, such as a predetermined cross section, which shape may be concave, such as parabolic. This shape/cross section may be desired in order to e.g. perform a sought after beam shaping of a beam of radiation, such as the focusing of a collimated beam on to a point or a predetermined surface, such as another reflector. Naturally, the travelling direction of the beam may be reversed so that a beam from the predetermined surface may be reflected on the concave surface and be collimated thereby.

As will be mentioned below, the present dish-shaped element is particularly suited for use in antennas where the dish-shaped element is rotatably mounted.

Naturally, an antenna may be used for transmitting and/or receiving any type of information, such as information embedded in a ray of radiation of any wavelength. A large part of the dish-shaped antennas are used for communicating via satellites, where the information is embedded in or encoded in radiation within the frequency bands of Ku(10.7-14.5 Ghz), K(18.7-21.2 Ghz.), Ka(29-31 Ghz).The first outer rim portion may be the outer part, rim or edge of the first side of the dish-shaped part. For example, the first outer rim portion may be defined by the outer contour when projecting the dish-shaped part on to a predetermined plane.

In one situation, when the dish-shaped element is rotatable in relation to e.g. a base element (see further below), the first outer rim portion preferably defines, during rotation, an outer contour within which the remainder of the dish-shaped element is positioned. In this manner, the first surface may be optimally dimensioned for a number of applications. This will be described further below.

The ring-shaped part preferably has a shape corresponding to a shape of the first outer contour. Naturally, the first outer contour of e.g. a plane substrate and/or a reflector when viewed directly from the front thereof, may have any shape, such as circular, oval, square or any other shape. In that situation, the shape of the ring-shaped element may be selected with equal flexibility. Often, the ring-shaped element will have a shape corresponding to the outer contour, or the shape of an outer, predetermined percentage area, of the dish-shaped part when projected on to a predetermined plane, such as a plane perpendicular to an axis, if such an axis exists, of symmetry of the first surface.

Preferably, the ring-shaped part is unbroken in order to firstly not cause any deformation or tension of the dish-shaped part during e.g. movements or accelerations and, secondly, in order to be able to provide an even attachment to the dish-shaped part. Also the ring-shaped part preferably has the same or at least substantially the same cross section along its length.

When the ring-shaped part is attached to the dish-shaped part at an outer part thereof, it will assist in maintaining the shape of the dish-shaped part, as it has been found that dish-shaped parts have a tendency of deformation especially at the outer parts thereof—and thus at the first outer rim portion.

The predetermined area, to which the ring-shaped part is attached, extends from the first rim portion and no more than 25% of a distance, along the second side, from one point on the first rim portion to a second point, on an opposite side, of the first rim portion. The second point may be a point on the first or second surface and/or the first outer rim portion which is the farthest from the one point. If the outer rim portion is circular, for example, the first and second points may define a diameter of the circle.

In another situation, the area of the second side to which the ring-shaped part is attached may be determined by projecting the ring-shaped part and the second side or the first side on to a predetermined plane, such as a plane perpendicular to a symmetry axis of the first surface, if such an axis exists. In this situation, the ring-shaped part may be provided within an outer area defined by the contour of the first outer rim portion and a maximum distance therefrom, the maximum distance being no more than 25% of a largest dimension of the projected first and/or second side, such as no more than 10% of this largest dimension.

The attachment of the ring-shaped part to the dish-shaped part may be performed in a variety of manners, such as welding, soldering, using screws, nails, rivets or the like, but the preferred manner, as is described further below, is gluing.

In a preferred embodiment, the first side is a convex side. In this context, a concave surface or side is a surface defining a hollowness or cavity. In a cross section, a straight line connecting two points on this surface or side will be positioned on one and the same side of the concave surface.

Often, concave surfaces are used for reflectors configured and positioned to reflect radiation to alter the characteristics of the radiation.

The particular shape of the concave surface may be defined in accordance with the desired set-up, such as for collimating a beam from a point source or the like. Often, a parabola-shaped surface is desired, but other surface shapes are desired under some circumstances, such as when a collimated beam is to be focused on another reflector, which has a certain size.

The dish-shaped part may have an opening therein for positioning or supporting of a radiation transmitter/receiver and/or a reflector. In some situations, a reflector positioned suitably in relation to the concave surface is configured to reflect radiation through an opening in the concave surface toward a receiver positioned below the concave surface.

In another situation, the first side is a plane side, and wherein the element further comprises a plurality of radiation emitters and/or radiation receivers positioned at or on the first side. This type of element may be a radiation emitter comprising a number of radiation emitters which may be controlled, such as by controlling the phase of the radiation emitted, to overall control a direction of the radiation emitted in relation to an axis perpendicular to the plane side. In the same manner, a number of radiation sensors may be provided. From the radiation sensed, typically from phase information, the direction of impingent radiation may be determined, or radiation from a certain direction may be given prevalence by selecting a corresponding phase.

Naturally, the relative positions but also the angles between the sensors/emitters is desired known and controlled, whereby the present invention using the ring-shaped part provides dimensional stability.

In one embodiment, the ring-shaped part has a third surface facing the dish-shaped part, the third surface having a second outer rim portion, the second outer rim portion being positioned at a distance of less than 10%, such as less than 5%, such as less than 1%, of a distance, from the first rim portion and along the second side, from one point on the first rim portion to a second point on an opposite side of the first rim portion.

As mentioned above, the second point may be that point on the first rim portion which is the farthest from the first point.

Thus, it is desired that the outer rim portion is close to the first rim portion in order for the ring-shaped part to be close to the outer edge of the second surface.

As mentioned above, the same may be defined in a projection of the ring-shaped part and the dish-shaped part on to a predetermined plane, where the second outer rim portion then is positioned within a distance of less than 10%, such as less than 5%, such as less than 1%, of a distance, in the projection, defined by a largest dimension of the dish-shaped part.

If the dish-shaped part has a circular cross section, the first and second points would define a diameter thereof.

In a preferred embodiment, the dish-shaped part is made of a single, solid material, such as a metal. In this context, aluminium is a preferred material, but also other metals, such as steel or titanium, may be used.

In other situations, the dish-shaped part may be made of a solid material comprising, on the first side, a coating of e.g. a metal. In this manner, the dish-shaped part may mainly consist of a cheap material, such as plastics, where a desired surface is provided by the coating.

A second aspect of the invention relates to a method of obtaining a dish-shaped element for use in an antenna for receiving and/or transmitting information, the method comprising:
providing a dish-shaped part having a first side and a second side opposite to the first side as well as a first outer rim portion,
attaching a ring-shaped part to the second side of the dish-shaped part, the ring-shaped part being attached to a predetermined area of the second side, the predetermined area extending from the first rim portion and no more than 25% of a distance, along the second side, from one point on the first rim portion to a second point on an opposite side of the first rim portion.

The dish-shaped element of the second aspect may be that of the first aspect.

In this context, the providing of the dish-shaped part may be any type of generation thereof, such as a moulding, such as injection moulding, slip casting or the like of a mouldable material, the deformation of a deformable material, such as bending, hydroforming, deformation using explosives, deep-drawing, spinning, or the like.

As mentioned above, the attaching step may be performed in a number of manners.

In one embodiment, the ring-shaped part has a third surface facing the dish-shaped part, the third surface having a second outer rim portion, and wherein the attaching step comprises attaching the ring-shaped part so that the second outer rim portion is positioned at a distance of less than 10% of a distance, along the second side, from a first point on the first rim portion to a second point on an opposite side of the first rim portion, from the first rim portion.

In one embodiment, the providing step comprises providing a dish-shaped part of a single, solid material. This providing may be any of the above-mentioned steps.

In a particularly preferred embodiment, the step of providing the dish-shaped part comprises hydroforming a sheet of a metal, preferably aluminium. This manner of providing the dish-shaped part will create the concave form with a high degree of precision and reproducibility.

In one embodiment, the attaching step comprises forcing the dish-shaped part into a desired shape and simultaneously gluing the ring-shaped part to the dish-shaped part.

This forcing may be obtained simply due to gravity forcing the dish-shaped part toward or onto a mould or substrate having a shape resulting in the dish-shaped obtaining the desired shape.

Naturally, any type of attachment between the dish-shaped element and the ring-shaped element may be used, but the advantage of using a gluing step is that the glue may take up any shape differences between the two elements while transferring, when cured, the dimensional stability desired. In addition, glue may provide a continuous fixing area between the dish-shaped part and the ring-shaped part, compared to spot welded spots defining individual and separate fixing positions.

A third aspect of the invention relates to an antenna comprising a dish-shaped element according to the first aspect of the invention or as provided according to the second aspect of the invention.

In this situation, the dish-shaped element may be used as a reflector, as e.g. the parabolic reflectors widely used when communicating with satellites.

In this situation, the dish-shaped part preferably has a concave first surface, the antenna further comprising a radiation transmitter and/or radiation emitter positioned so as to emit radiation toward and/or receive radiation from the first surface.

Especially for use on mobile systems, such as for use on vehicles, vessels and the like, the antenna preferably further comprises a base element and a rotator configured to rotate the dish-shaped element in relation to the base element. In this manner, the dish-shaped element may maintain a direction toward e.g. a satellite or other receiver/transmitter, while the mobile system moves/rotates. Usually, not just the dish-shaped element but also a receiver/transmitter is rotated by the rotator, as it is usually desired that a fixed positional relationship exists between a reflector and the transmitter/receiver. Naturally, depending on the actual setup, also other elements may be desired rotated with the dish-shaped part.

In this situation, the dish-shaped element may be fixed or attached to the rotator by attachment to the ring-shaped part.

In a particularly interesting embodiment, the antenna further comprises a housing inside which the dish-shaped element is provided, the housing allowing rotation of the dish-shaped element through a predetermined angular interval, the housing comprising an inner surface and being dimensioned so that a distance, at least from a height above the base where the outer rim portion has the largest vertical dimension, of no more than 3 cm exists between the first outer rim portion and the inner surface throughout the angular interval.

In this situation, the largest vertical dimension may be a cross section, in a vertical plane, where the area of the contour defined by the outer rim portion in all possible angular positions is the largest. Preferably, the housing is provided with that cross section—added a small margin of no more than 3 cm—from the vertical position and to a lowest portion of the housing, such as a portion engaging and/or fastened to the base.

In this manner, it is seen that it is preferred that no part of the ring-shaped part extends outside the contour defined by the first outer contour. This may define the position and/or the cross section of the ring-shaped part. Thus, if the ring-shaped part extends to very close to the first outer rim portion, the outer parts of the ring-shaped part may be desired rather thin. In one embodiment, the ring-shaped part may have a largely triangular cross-section with a corner positioned close to the first outer rim portion and an angle of that corner, between one triangle side attached to the dish-shaped part and another side, of less than 90 degrees, such as less than 45 degrees.

Usually, the dish-shaped element is rotatable around an axis, where the housing may be rotationally symmetrical around that axis.

Often, the dish-shaped element is positioned, in relation to the rotator(s) so that the second side of the dish-shaped element faces the rotator(s).

The housing may be dimensioned by determining a complete outer contour of the first outer rim portion through all obtainable or possible angular positions of the dish-shaped element, defining a widest portion thereof and continuing the widest portion from the widest portion and toward a base of the antenna. In this manner, the parts above the widest portion may be narrowing and thus reducing the extent of the housing only to that required, while the housing may be lowered from above the antenna to the desired position with no problems.

In this manner, firstly, the dish-shaped element is protected from e.g. the surroundings, such as from wind, water, humidity, high/low temperatures and the like. Secondly, the housing may be dimensioned to be quite small compared to the dish-shaped part, and on the other hand, the dish-shaped part may have dimensions optimized in relation to the space available in the housing. The larger the dish-shaped part the better beam forming and the better S/N in the communication.

In the following, preferred embodiments of the invention will be described with reference to the drawing, wherein:

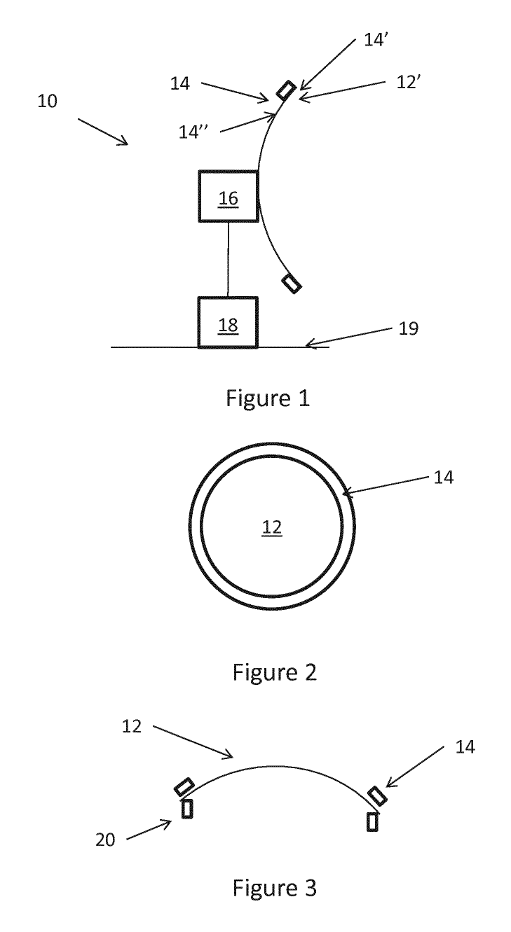

FIG. 1 illustrates a cross section of an antenna system comprising a dish-shaped element according to a preferred embodiment of the invention,

FIG. 2 illustrates the dish-shaped element of FIG. 1 seen from the back,

FIG. 3 illustrates a method of providing the dish-shaped element of FIG. 2,

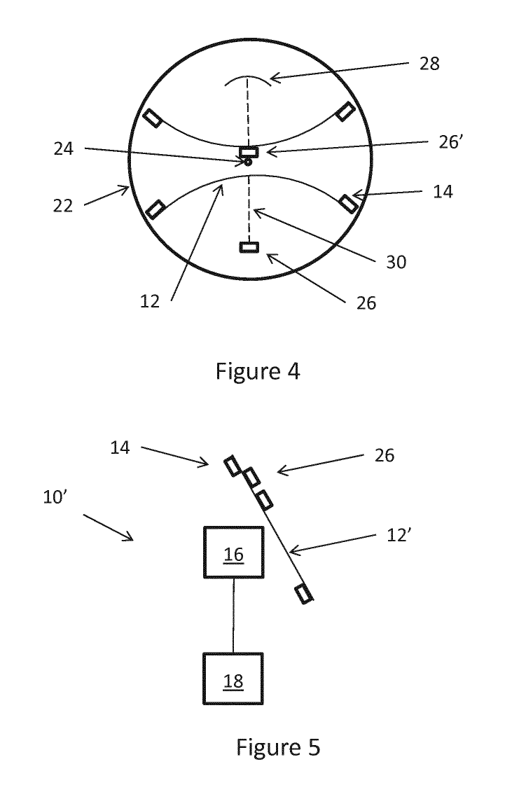

FIG. 4 illustrates rotation of a dish-shaped element inside a housing, and

FIG. 5 illustrates a second embodiment of an antenna system according to the invention.

In FIG. 1, an antenna system 10 is illustrated having a dish-shaped part 12, which has a concave surface, such as forming a parabolic element, used for concentrating or focusing radiation. Usually, a radiation generator or sensor is also provided, but this may be positioned in many positions, as the skilled person will be aware.

Usually, the antenna systems also comprise elements 16 and 18 for rotating the dish-shaped part 12 to alter the direction of emitted radiation and/or a direction from which radiation may be received. The lower rotator 18 may be fixed to a base 19, such as the deck, roof or the like of a building, vehicle, vessel, plane or the like.

The dish-shaped part 12 further comprises a reinforcement ring 14 (see also FIG. 2). This ring has the function of maintaining the desired shape of the dish-shaped part 12, as the shape thereof defines the concentrating/directing of the radiation. As the skilled person knows, a deviation of the shape of the dish-shaped part 12 by more than 25%, such as even 10%, of a wavelength of the radiation will have a detrimental effect of the operation of the dish-shaped part 12, and when the radiation wavelength decreases, the smaller will acceptable shape deviations become. Due to the nature of deformation of the disc-shaped element 12, the effect of even very small variations can be detrimental. Therefore it is desired that the deviation from the theoretical shape of the disc-shaped element is no more than 2%, which for a 30 GHz signal is a deviation of no more than 0.2 mm.

It has been found that the largest deviations are at the outer boundaries 12′ of the dish-shaped part, where the operation of the reinforcement ring 14 therefore is to keep the dish-shaped part 12 in shape. In this manner, the dish-shaped part 12 may be made of a thinner or cheaper material or by a method generating more flexible and less dimensionally stable dish-shaped parts 12.

Preferably, the reinforcement ring 14 is positioned so that an outer edge 14′ thereof is close to the outer edge or boundary 12′ of the dish-shaped part. In addition, preferably the thickness of the reinforcement ring 14 is not too large, so that the overall weight increase is not excessive. Thus, preferably, the thickness (distance from outer to inner edges 14′/14″) is no more than e.g. 10% of the distance from the outer edge 12′ at one position to the outer edge 12′ at an opposite position. If the dish-shaped part 12 is circular seen from the back or front (see FIG. 2), these opposite positions would define a diameter of the circle.

When the weight of the reinforcement ring is kept low, the stiffness required of the dish-shaped part 12 may be kept low. In the presently preferred system, the dish-shaped part 12 is made of 2 mm thick sheet of aluminium which may be hydroformed, where the reinforcement ring 14 is made of 1.5 mm thick aluminium, which may be spin rolled or otherwise cold deformed. Preferably, the reinforcement ring is weight minimized to thereby ensure an optimal centre of gravity of the assembly of the dish-shaped part 12 and the ring 14.

In FIG. 3, a step of the manufacture of the system 10 is illustrated. During this manufacturing step, the dish-shaped part 12 may be manufactured, such as by hydroforming a sheet of aluminium. This shaping may be obtained by using a mould which takes into account the natural spring-back of aluminium, so that the resulting shape of the dish-shaped part 12 is very close to that desired.

Subsequently, the dish-shaped part 12 is put into or on to another mould which forces the dish-shaped part 12 into the desired shape, where after the reinforcement ring 14 is glued thereto.

In FIG. 3, the other mould 20 is precisely manufactured ring having an upper surface or upper, outer edge engaging the dish-shaped part 12, whereby, such as simply due to gravity, the dish-shaped part 12 is forced into the desired shape defined by the mould 20. While the dish-shaped part 12 is in the desired shape, the reinforcement ring 14 is positioned in the desired position and glued on to the dish-shaped part 12.

An advantage of gluing the reinforcement ring 14 on to the dish-shaped part 12 is that any dimensional differences or inaccuracies of the reinforcement ring 14 may be taken up by the glue so that any inaccuracy of the reinforcement ring 14 is not transferred into a dimensional deviation of the dish-shaped part 12.

The dish-shaped part 12 may, as an alternative to aluminium, be made of an aluminium coated element of e.g. plastic or a composite, such as carbon/polyester, carbon/epoxy, glass fibre/polyester, glass fibre/epoxy, or the like.

The shaping of the dish-shaped part 12, naturally, will depend on the material selected. Metals may be shaped by hydroforming or otherwise cold deformed, e.g. by deep drawing, spinning, explosive forming, or the like. Plastic materials and composites are generally shaped in a mould comprising one or two parts.

Preferred parameters for the dish-shaped part 12 are an initial high precision, such as no more than +/−0.5 mm, before attachment to the reinforcement ring, a low weight and a lower stiffness than the reinforcement ring 14.

The reinforcement ring 14 preferably is dimensioned and positioned so that when rotating the dish-shaped part 12, the outer boundary 12′ defines an outer contour inside which the reinforcement ring 14 is also positioned during the rotation. In this manner (see FIG. 4), a housing 22 covering and protecting the dish-shaped part 12 is completely utilized by the dish-shaped part and no additional “waste” space is required for the reinforcement ring 14, when rotating the assembly of the dish-shaped part 12 and the reinforcement ring 14 around the axis of rotation 24.

In FIG. 4, the rotational axis is positioned so that the second side of the dish-shaped part 12 faces it. Alternatively, the axis may be positioned so that the first side of the dish-shaped part faces it.

In FIG. 4, two different detector-setups and two different beam shaping setups are illustrated.

In the lower rotational position, the dish-shaped part 12 is configured to reflect a collimated beam (directed directly from below) toward a detector 26 positioned in front of the dish-shaped part 12 and supported by a rod indicated at 30.

In the upper rotational position, the dish-shaped part 12 is configured to reflect a collimated beam (directly from above) toward a secondary reflector 28 which again is configured to reflect the received radiation through an opening in the dish-shaped part 12 and toward a detector 26′ positioned at the other side of the dish-shaped part 12.

It is seen that the shape of the dish-shaped part 12 is selected so that the detector 26 and/or reflector 28 can be positioned inside the housing and thus the outer contour of the rim 12′, when the dish-shaped part 12 is rotated into all possible rotational angles and position by the rotators 16/18 provided. In this manner, the housing 22 may be selected to the dimensions of the dish-shaped part 12.

Usually, the widest portion, in the vertical direction, is determined of his outer contour, and the housing is selected with the shape of the outer contour above this portion and with a cross section of the largest/widest contour below this, so that the housing may simply be provided by lowering from above the antenna.

Multiple other manners and setups are possible, and naturally, the direction of travel of the beams may be reversed so that the detectors 26/26′ may be radiation emitters.

Preferred parameters for the reinforcement ring 14 are an initial precision, such as no more than +/−1 mm, before attachment to the dish-shaped part, low weight, and a higher stiffness than the dish-shaped part 12. The presently preferred ring 14 is circular, has an internal diameter of 1000 mm and a total weight of 0.9 kg.

The combination of the dish-shaped element 12, and the reinforcement ring 14 bonded together with adhesive can create the necessary stiffness to avoid deformation through applied external forces, e.g. vibration. Also, the stiffness is desired to prevent the dish-shaped element 12, from deforming due to internal forces, e.g. asymmetrical forces introduced from initial curing/forming of the material.

The adhesive preferably ensures that the attachment/fixation of the geometry will not deteriorate due to improper matching of materials and/or lack of stiffness/strength. Furthermore, the glue preferably has a sufficiently low shrinkage to prevent it from deforming the dish-shaped part 12 upon curing. The adhesive may be e.g. a rubberised polymer, methacrylate, silicone, epoxy or polyurethane substrate. The presently preferred glue is a Terostat 9399.

Naturally, the adhesive may be replaced by another method of fixing the reinforcement ring 14 to the dish-shaped part 12, such as a welding, soldering, brazing, riveting or friction welding.

The manufacturing step of forcing the dish-shaped part 12 into the desired shape may, as is described above, simply be performed by resting the dish-shaped part 12 on to a suitable mould. Alternatively by other external force applied e.g. vacuum or a mechanically applied force.

In FIG. 5, an alternative antenna setup 10′ is illustrated again having the rotators or motors 16/18, but in this embodiment, the concave dish-shaped part 12 has been replaced by a flat substrate 12′ on the first side of which is positioned a plurality of radiation emitters or receivers 26. Again, the dish-shaped part 12′ has on the second side the reinforcement ring 14.

The set-up of the dish-shaped part 12′ with a number of transmitters is a known set-up where the same signal may be fed to all transmitters 26 but the phase to each transmitter controlled so as to control an overall angle of emitted radiation relative to an axis perpendicular to the plane substrate of the dish-shaped part 12′. Due to the fact that this angle may be controlled only within a certain angular interval, the rotators 16/18 may still be desired.

When the dish-shaped part 12′ has receivers, the phase between output signals of the individual receivers may be controlled to put emphasis on radiation received from a predetermined angle. Again, this angle may be within a certain angular interval so that the rotation of the dish-shaped part 12′ is still often desired.

The skilled person will know how to determine a rotational position of the dish-shaped parts 12/12′ and to control the rotation thereof.

Also, the skilled person will know a number of reflector setups and setups relating to relative positions of receivers/transmitters in relation to reflectors.

A large number of types of electronics are known for controlling the rotation of the dish-shaped parts and controlling a receiver/transmitter or a plurality thereof in order to obtain a useful system configured to track e.g. a satellite while communicating therewith. This communication may be performed using any of the presently used coding techniques using which the information is encoded into the radiation forwarded toward or received from a satellite, for example. The skilled person knows this.

1-16. (canceled)

17. A dish-shaped element for use in an antenna for receiving and/or transmitting information, the element comprising:
a dish-shaped part having a first side, a second side opposite to the first side, as well as a first outer rim portion,
an unbroken, ring-shaped part attached to the second, opposite side of the dish-shaped part, the ring-shaped part being glued to a predetermined area of the second side, the glue forming a continuous fixing area between the dish-shaped part and the ring-shaped part, the predetermined area extending from the first rim portion and no more than 25% of a distance, along the second side, from one point on the first rim portion to a second point, on an opposite side of the first rim portion.

18. An element according to claim 17, wherein the first side is a concave side.

19. An element according to claim 17, wherein the first side is a plane side, and wherein the element further comprises a plurality of radiation emitters and/or radiation receivers positioned at or on the first side.

20. An element according to claim 17, wherein the ring-shaped part has a first surface facing the dish-shaped part, the first surface having a second outer rim portion, the second outer rim portion being positioned at a distance of less than 10% of a distance, from the first rim portion and along the second side, from one point on the first rim portion to a second point on an opposite side of the first rim portion.

21. An element according to claim 17, wherein the dish-shaped part is made of a single, solid material.

22. An antenna comprising a dish-shaped element according to claim 17.

23. An antenna according to claim 22, wherein the dish-shaped element has a concave first surface, the antenna further comprising a radiation transmitter and/or radiation emitter positioned so as to emit radiation toward and/or receive radiation from the first surface.

24. An antenna according to claim 22, further comprising a base element and a rotator configured to rotate the dish-shaped element in relation to the base element.

25. An antenna according to claim 24, further comprising a housing inside which the dish-shaped element is provided, the housing allowing rotation of the dish-shaped element through a predetermined angular interval, the housing comprising an inner surface and being dimensioned so that a distance, at least above a height above the base where the outer rim portion has a largest vertical dimension, of no more than 3 cm exists between the first outer rim portion and the inner surface throughout the angular interval.

26. A method of obtaining a dish-shaped element for use in an antenna for receiving and/or transmitting information, the method comprising:
providing a dish-shaped part having a first side and a second side opposite to the first side as well as a first outer rim portion,
gluing an unbroken, ring-shaped part to the second side of the dish-shaped part to form a continuous fixing area between the dish-shaped part and the ring-shaped part, the ring-shaped part being attached to a predetermined area of the second side, the predetermined area extending from the first rim portion and no more than 25% of a distance, along the second side, from one point on the first rim portion to a second point on an opposite side of the first rim portion.

27. A method according to claim 26, wherein the ring-shaped part has a first surface facing the dish-shaped part, the first surface having a second outer rim portion, and wherein the attaching step comprises attaching the ring-shaped part so that the second outer rim portion is positioned at a distance of less than 10% of a distance, along the second side, from a first point on the first rim portion to a second point on an opposite side of the first rim portion, from the first rim portion.

28. A method according to claim 26, wherein the providing step comprises providing the dish-shaped part with a first surface being a concave surface.

29. A method according to claim 26, wherein the providing step comprises providing the dish-shaped part as a plane element, the providing step further comprising providing a plurality of radiation emitters and/or a plurality of radiation receivers on the first surface.

30. A method according to claim 26, wherein the providing step comprises providing a dish-shaped part of a single, solid material.

31. A method according to claim 26, wherein the step of providing the dish-shaped part comprises hydroforming a sheet of a metal.

32. A method according to claim 26, wherein the gluing step comprises forcing the dish-shaped part into a desired shape and simultaneously gluing the ring-shaped part to the dish-shaped part.
